(19) United States
(12) Patent Application Publication
(10) Pub. No.: US 2012/0141890 A1
(43) Pub. Date: Jun. 7, 2012

(54) FUEL CELL SYSTEM

(75) Inventor: Sang Hoon Seo, Suwon (KR)

(73) Assignee: HYUNDAI MOTOR COMPANY, Seoul (KR)

(21) Appl. No.: 13/171,008

(22) Filed: Jun. 28, 2011

(30) Foreign Application Priority Data
Dec. 3, 2010 (KR) 10-2010-0123049

(51) Int. Cl. H01M 8/06

(52) U.S. Cl. 429/414

(57) ABSTRACT

A fuel cell system is provided. More specifically, the fuel cell system is made up of an aggregate of unit fuel cells, an air supply unit, a humidifier, a hydrogen supply unit, and a valve unit. The valve unit is configured to be connected to a stack and the humidifier. This valve unit prevents external air from being introduced to an air supply path and an air exhaust path through the humidifier when the stack is turned off. More specifically, the valve unit includes a valve body component constituting the air supply path as first and second valve passages and the air exhaust path as third and fourth valve passages and an opening and closing component for opening and closing the air supply path and the air exhaust path.

### CROSS-REFERENCE TO RELATED APPLICATION

This application claims priority to and the benefit of Korean Patent Application No. 10-2010-0123049 filed in the Korean Intellectual Property Office on Dec. 3, 2010, the entire contents of which are incorporated herein by reference.

### BACKGROUND OF THE INVENTION

(a) Field of the Invention

The present invention relates to a fuel cell system and, more particularly, to a fuel cell system capable of preventing degradation of a fuel cell.

(b) Description of the Related Art

A polymer electrolyte film applied to a fuel cell vehicle has an ionic conductivity which increases as the polymer electrolyte film is sufficiently wet with water, thus reducing resistance loss, but when reactive gas having relatively low moisture continues to be supplied, the polymer electrolyte film eventually dries up to a point where it becomes unuseful, so the supplied gas needs to be humidified in order to get the maximum benefit from the polymer electrolyte film. In order to humidify a cathode of a fuel cell, a humidifier which can humidify a maximum flow rate to above an appropriate level is required.

Currently, a hollow fiber membrane humidifier is typically mounted in a fuel cell vehicle, which operates such that the moisture of exhaust air (i.e., damp air discharged from a fuel cell), and supply air, (i.e., dry air supplied from the air), are moisture-exchanged (i.e., the moisture from the exhaust air is transferred to the supply air).

Furthermore, when the engine of the fuel cell vehicle is turned off, a portion of air and hydrogen remain in the cathode and anode of the fuel cell, respectively. In this case, when the hydrogen in the anode, passing through the electrolyte membrane, is reacted with oxygen of the cathode so as to be consumed, the anode is vacuumized and oxygen of the cathode again passes through the electrolyte membrane by the corresponding vacuum strength to fill the anode.

Namely, when the engine of the fuel cell vehicle is turned off, the supply of air and hydrogen to the fuel cell is stopped. However, when the fuel cell vehicle is left turned off for a long time, hydrogen remaining in the anode passes through the electrolyte membrane to pass over to the cathode. Accordingly, the pressure at the anode is lowered compared with that of the cathode and a negative pressure is formed at the anode whose entrance and exit are shut, so oxygen at the cathode is spread to the anode due to the difference in pressure between the anode and the cathode.

Here, the entrance and exit of the cathode are open, allowing the cathode to be constantly in an atmospheric pressure state. In this state, when the engine of the fuel cell vehicle is turned on after the lapse of a certain period of time, hydrogen is introduced to the anode filled with oxygen which degrades the performance of the fuel cell and as a result, the durability and life span of the fuel cell are shortened.

In other words, when the engine of the fuel cell vehicle is turned on, hydrogen is supplied to the anode and, at the same time, it forms an interface with remaining oxygen to cause a chemical reaction phenomenon. At this point, a high potential is generated from the cathode which corrodes the carbon. Carbon corrosion results in a loss of a carbon catalyst of the cathode which in turn reduces the activation of the performance of the fuel cell and thereby causes a degradation phenomenon in which the performance of the fuel cell is reduced.

With such a degradation phenomenon occurring, when a fuel cell operates for a certain amount of time, a voltage drop occurs therein to affect the durability and life span of the fuel cell to make the overall system unstable as over time, and as a result, the stack must be changed due to frequent shutdowns.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a fuel cell system which is above to prevent degradation of a fuel cell by preventing external air from being introduced to an air exhaust side and an air supply side of a stack when the stack is turned off.

An exemplary embodiment of the present invention provides a fuel cell system which includes a stack configured as an aggregate of unit fuel cells; an air supply unit to supply external air to a cathode of the fuel cell; and a humidifier to exchange exhaust air of high temperature and humidity exhausted from the cathode with supply air supplied from the air supply unit to humidify the supply air. The humidifier also supplies the humidified air to the cathode. Additionally, the present invention also includes a hydrogen supply unit to supply hydrogen to an anode of the fuel cell; and a valve unit configured to be connected to the stack and the humidifier. This valve unit prevents external air from being introduced to an air supply path and an air exhaust path through the humidifier when the stack is turned off. In particular the valve unit is made up of a valve body component, constituting the air supply path as first and second valve passages and the air exhaust path as third and fourth valve passages, and an opening and closing component for opening and closing the air supply path and the air exhaust path. In some embodiments of the present invention, the valve unit may be configured specifically as a 4-way valve.

Furthermore, in the fuel cell system, the humidifier may be made up of a housing and a hollow fiber membrane disposed in the interior of the housing. This hollow fiber membrane allows the exhaust air and the supply air to be moisture-exchanged therethrough to humidify the supply air.

Additionally, in some embodiments, the housing may also include a first inlet which allows the exhaust air to be introduced therethrough; a second inlet which allows the supply air to be introduced therethrough; a first outlet which allows the humidified air to be exhausted therethrough; and a second outlet which allows the exhausted air, from which moisture has been removed, to be exhausted to the air.

More specifically, in some embodiments, the air supply path may be connected to the first outlet, and the air exhaust path may be connected to the first inlet. Additionally, the first and fourth valve passages may be connected to the humidifier, and the second and third valve passages may be connected to the stack. The first valve passage may also be connected to the first outlet, and the second valve passage may also be connected to an air supply side. The third valve passage may also be connected to an air exhaust side of the stack, and the fourth valve passage may be connected to the first inlet.

In yet even other embodiments of the present invention, when the stack is started, the opening and closing component may open the first and second valve passages as the air supply path connecting the stack and the humidifier and open the third and fourth valve passages as the air exhaust path connecting the stack and the humidifier. When the stack is turned off, the opening and closing component may close the first and second valve passages as the air supply path connecting the stack and the humidifier and close the third and fourth valve passages as the air exhaust path connecting the stack and the humidifier.

Further, the opening and closing component may include an operational plunger rotatably mounted in the interior of the valve body component to open and close the air supply path and the air exhaust path. The valve unit itself may also include an actuator for rotating the operational plunger.

According to an exemplary embodiment of the present invention, when the stack is turned off, an introduction of external air to the air exhaust side and the air supply side of the stack can be cut off by the valve unit, preventing air from spreading from the cathode to the anode, and thus, degradation of the fuel cell due to oxygen remaining in the anode can be delayed or prevented. In addition, in the present exemplary embodiment, since the valve unit may be configured as a 4-way valve, the air exhaust side and the air supply side of the stack can be opened or closed by a single valve. Thus, the structure of the overall system can be simplified and lightened, the fabrication unit cost can be reduced, the vehicle package can be improved, the system can be modularized, maintenance characteristics of the system can be enhanced, and failure rate can also be reduced.

### BRIEF DESCRIPTION OF THE DRAWINGS

The present invention will become more fully understood from the detailed description given hereinbelow and the accompanying drawings, which are given by illustration only, and thus are not limitative of the present invention.

FIG. 1 is a schematic block diagram of a fuel cell system according to an exemplary embodiment of the present invention.

FIG. 2 is a schematic sectional view of a humidifier employed in the fuel cell system according to an exemplary embodiment of the present invention.

FIG. 3 is a perspective view of a valve unit employed in the fuel cell system according to an exemplary embodiment of the present invention.

FIG. 4 is a schematic sectional view of the valve unit of FIG. 3.

FIGS. 5A and 5B are sectional views illustrating operations of the fuel cell system according to an exemplary embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In order to clarify the present invention, parts/components that are not connected with the description will be omitted, and the same elements or equivalents are referred to as the same reference numerals throughout the specification.

The size and thickness of each element are arbitrarily shown in the drawings, and the present invention is not necessarily limited thereto, and in the drawings, the thickness of layers, films, panels, regions, etc., are exaggerated for clarity.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

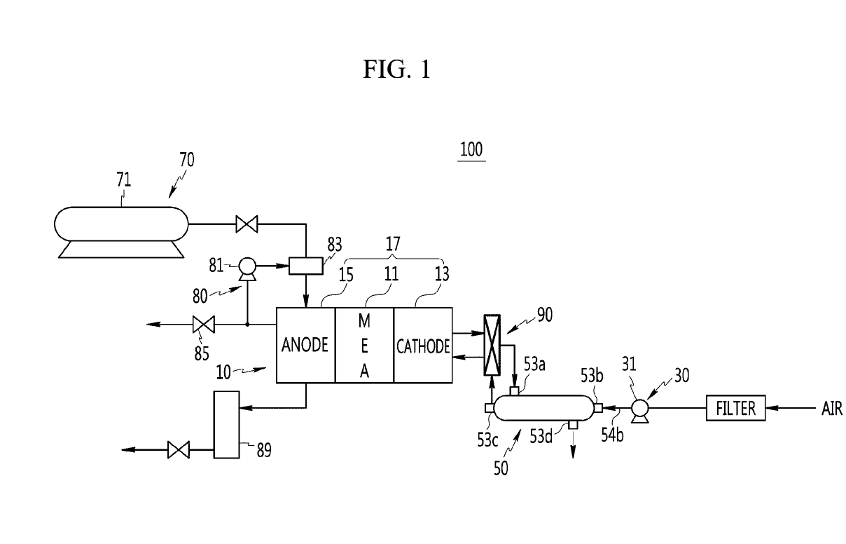

FIG. 1 is a schematic block diagram of a fuel cell system according to an exemplary embodiment of the present invention.

With reference to FIG. 1, a fuel cell system 100 according to an exemplary embodiment of the present invention is configured as a form of a power generation system which generates electrical energy according to an electrochemical reaction between hydrogen as fuel and air as an oxidizing agent.

The fuel cell system 100 according to the present exemplary embodiment includes a stack 10, an air supply unit 30, a humidifier 50, a hydrogen supply unit 70, a hydro recirculation unit 80, and a valve unit 90. These elements will be described as follows.

The stack 10 is configured as an aggregate structure of unit fuel cells in which a cathode 13 and an anode 15 are disposed with a membrane-electrode assembly (MEA) 11 interposed therebetween. Here, the cathode 13 of the fuel cell 17 exhausts damp air of high temperature and humidity (referred to as “exhaust air”, hereinafter), and the anode 15 of the fuel cell 17 exhausts hydrogen of high temperature and humidity as non-reacted hydrogen.

The air supply unit 30 serves to supply external air to the cathode 13 of the fuel cell 17. The air supply unit 30 may include an air blower 31 for sucking dry air in the atmosphere (referred to as ‘supply air’, hereinafter) and supplying the atmospheric dry air to the cathode 13.

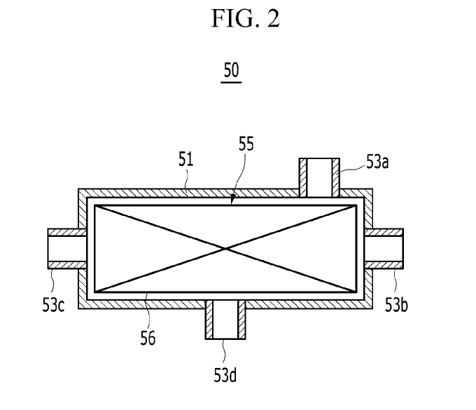

In the present exemplary embodiment, the humidifier 50 humidifies the supply air supplied from the air blower 31 by using the exhaust air of high temperature and humidity exhausted from the anode 13 of the fuel cell 17, and supplies the humidified air (referred to as ‘humid air’, hereinafter) to the cathode 13. The configuration of the humidifier 50 according to the present exemplary embodiment will be described in detail later with reference to FIG. 2.

In the above, the hydrogen supply unit 70 serves to supply hydrogen to the anode 15 of the fuel cell 17. The hydrogen supply unit 70 may include a hydrogen tank 71 for storing hydrogen gas and supplying the hydrogen gas to the anode 15.

The hydrogen recirculation unit 80 serves to mix the hydrogen of high temperature and humidity exhausted from the anode 15 of the fuel cell 17 and dry hydrogen supplied from the hydrogen tank 71 and supply the mixed humid hydrogen to the anode 15. Here, the hydrogen recirculation unit 80 may include a hydrogen blower 81 for sucking the hydrogen of high temperature and humid exhausted from the anode 15, a mixer 83 for mixing the hydrogen of high temperature and humidity sucked through the hydrogen blower 81 and the dry hydrogen supplied from the hydrogen tank 71, and a purge valve 85 for exhausting non-reacted hydrogen into the atmosphere.

The illustrated stack 10, the air supply unit 30, the hydrogen supply unit 70, and the hydrogen recirculation unit 80 as described above are known arts, so a detailed description of their configuration will be omitted. Furthermore, reference numeral 89 not described denotes a water trap for collecting condensation water generated in the anode 15 of the fuel cell 17 and exhausting the same.

FIG. 2 is a schematic sectional view of a humidifier employed in the fuel cell system according to an exemplary embodiment of the present invention.

With reference to FIG. 2, the humidifier 50 according to the present exemplary embodiment which includes a housing 51 and a membrane module 55 installed in the housing 51. The housing 51 includes a first inlet 53a allowing exhaust air to be introduced therethrough, a second inlet 53b allowing supply air to be introduced therethrough, a first outlet 53c allowing humid air to be exhausted therethrough, and a second outlet 53d allowing exhaust air, whose moisture has been removed through the membrane module 55, to be exhausted into the atmosphere therethrough.

Namely, the first inlet 53a may be connected to the cathode 13 of the fuel cell 17, the second inlet 53b may be connected to the air blower 31, and the first outlet 53c may be connected to the cathode 13 of the fuel cell 17. Here, the exhaust air exhausted into the atmosphere through the second outlet 53d contains certain moisture and heat.

The membrane module 55 is installed in the interior of the housing 51 and may be provided as a hollow fiber membrane 56 allowing supply air to be humidified upon being moisture-exchanged with exhaust air therethrough.

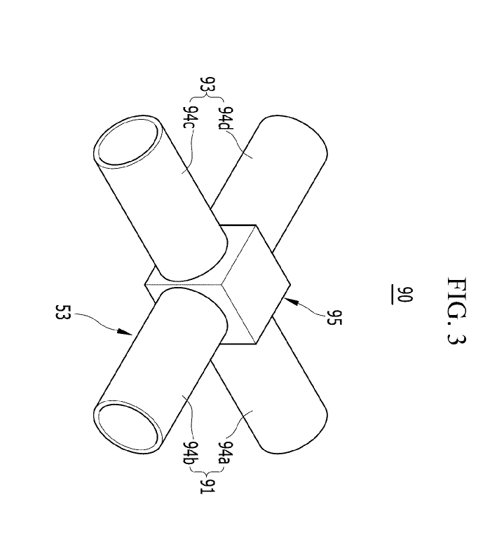

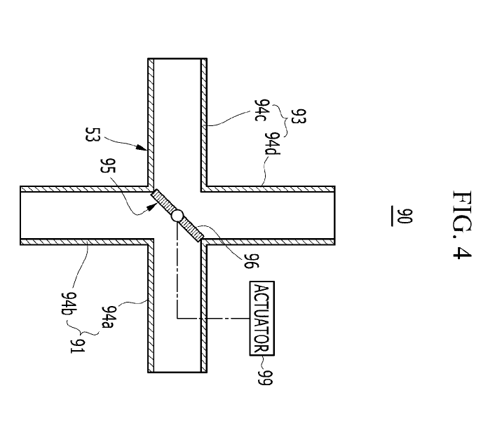

FIG. 3 is a perspective view of a valve unit 90 employed in the fuel cell system according to an exemplary embodiment of the present invention, and FIG. 4 is a schematic sectional view of the valve unit 90 of FIG. 3.

With reference to FIGS. 3 and 4, the valve unit 90 according to the present exemplary embodiment is an auxiliary device for improving the durability of the stack 10. When the stack 10 is turned off, the valve unit 90 serves to prevent external air from being introduced to an air exhaust side and an air supply side of the stack 10. Namely, when the stack 10 is turned off, the valve unit 90 prevents an introduction of external air into the air supply path 91 and the air exhaust path 93 of the stack 10 through the humidifier 50, thus preventing the fuel cell 17 from being degraded due to the external air otherwise introduced into the fuel cell 17 of the stack 10.

The configuration of the valve unit 90 according to the present exemplary embodiment will now be described in more detail with reference to FIGS. 1 to 4. The valve unit 90 may be configured to include a valve body component 53, an opening and closing component 95, and an actuator 99.

Illustratively, the valve unit 90 is configured as a 4-way valve for opening and closing the air supply path 91 and the air exhaust path 93. To this end, the valve body component 93 constitutes the air supply path 91 and the air exhaust path 93 as mentioned above, forming four valve passages. Namely, the valve body component 53 includes first and second valve passages 94a and 94b as the air supply path 91 and third and fourth valve passages 94c and 94d as the air exhaust path 93.

Here, the air supply path 91 may be defined as a supply path of humid air supplied to the stack 10 through the humidifier 50 and as a supply path of supply air supplied to the humidifier 50 through the air supply unit 30. The air exhaust path 93 may be defined as an exhaust path of exhaust air exhausted from the stack 10 and supplied to the humidifier 50 and as an exhaust path of air exhausted from the humidifier 50 into the atmosphere. In this case, the air supply path 91 may be connected to the first outlet 53c of the humidifier 50, and the air exhaust path 93 may be connected to the first inlet 53c of the humidifier 50.

Of the air supply path 91, the first valve passage 94a may be connected to the first outlet 53c of the humidifier 50, and the second valve passage 94b may be connected to the air supply side of the stack 10. Of the air exhaust path 93, the third valve passage 94c may be connected to the air exhaust side of the stack 10, and the fourth valve passage 94d may be connected to the first inlet 53a of the humidifier 50. Namely, the first and fourth valve passages 94a and 94d are connected to the humidifier 50, and the second and third valve passages 94b and 94c are connected to the stack 10.

In the present exemplary embodiment, the opening and closing component 95, serving to open and close the air supply path 91 and the air exhaust path 93, includes an operational plunger 96 rotatably mounted in the interior of the valve body component 53. The operational plunger 96 may be rotatably mounted at a diverging point of the first to fourth valve passages 94a, 94b, 94c, and 94d.

In the present exemplary embodiment, the actuator 99 serves to provide a rotary force to the operational plunger 96. The actuator 99 may be provided as a known driving motor which operates upon receiving an electrical signal by a controller (not shown) and provides a rotary force to the operational plunger 96.

The operation of the fuel cell system configured as described above according to an exemplary embodiment of the present invention will now be described in detail with reference to the accompanying drawings.

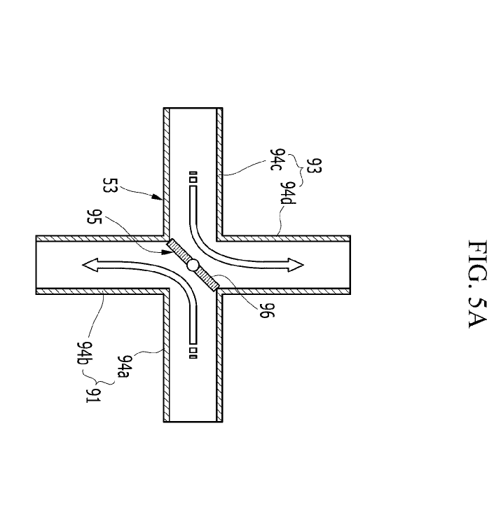

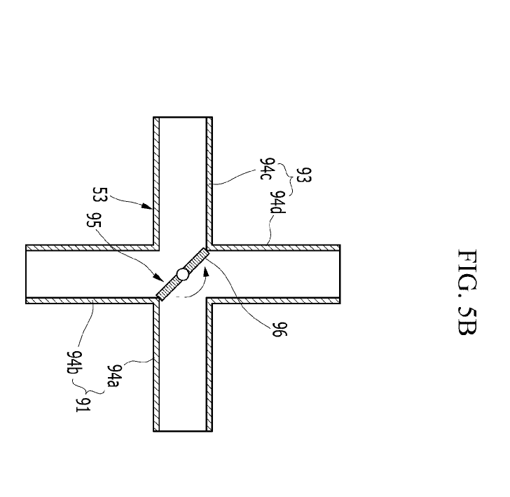

FIGS. 5A and 5B are cross sectional views illustrating operation of the fuel cell system according to an exemplary embodiment of the present invention.

First, with reference to FIG. 5A, in the present exemplary embodiment, when the stack 10 is started, the actuator 99 of the valve unit 90 provides a rotary force to the operational plunger 96 upon receiving a control signal from a controller (not shown). Then, the operational plunger 96, being rotated by the actuator 99, may open the air supply path 91 and the air exhaust path 93 connected to the stack 10. Namely, the operational plunger 96 opens the first and second valve passages 94a and 94b as the air supply path 91 connecting the stack 10 and the humidifier 50 and opens the third and fourth valve passages 94c and 94d as the air exhaust path 93 connecting the stack 10 and the humidifier 50.

In this state, while electrical energy is being generated according to an electrochemical reaction between hydrogen and air through the fuel cell 17, the cathode 13 of the fuel cell 17 exhausts air of high temperature and humidity as non-reacted air. Here, the exhaust air of high temperature and humidity passes through the third and fourth valve passages 94c and 94d of the air exhaust path 93 so as to be introduced into the membrane module 55 through the first inlet 53a of the housing 51, and air (supply air) in the atmosphere is sucked through the air blower 31 of the air supply unit 30 so as to be supplied to the membrane module 55 through the second inlet 53b of the housing 51.

The supply air is then moisture-exchanged with the exhaust air by the membrane module 55 so as to be humidified in the interior of the housing 51, and the humidified air is supplied to the cathode 13 of the fuel cell 17 through the first and second valve passages 94a and 94b of the air supply path 91. The exhaust air, whose moisture has been removed through the membrane module 55 in the interior of the housing 51, namely, exhaust air including certain moisture and heat, may be exhausted into the atmosphere through the second outlet 53d.

Furthermore, in the present exemplary embodiment, as shown in FIG. 5B, when the stack 10 is turned off, the actuator 99 of the valve unit 90 provides a rotary force to the operational plunger 96 upon receiving a control signal from the controller (not shown). The operational plunger 96, rotated by the actuator 99, then closes the air supply path 91 and the air exhaust path 93 connected to the stack 10. Namely, the operational plunger 96 closes the first and second valve passages 94a and 94b as the air supply path 91 connecting the stack 10 and the humidifier 50, and closes the third and fourth valve passages 94c and 94d as the air exhaust path 93 connecting the stack 10 and the humidifier 50.

Accordingly, in the present exemplary embodiment, when the stack 10 is turned off, introduction of external air to the air exhaust side and the air supply side is prevented by the valve unit 90, and thus, air cannot spread from the cathode 13 to the anode 15. This in turn prevents or reduces the degradation phenomenon of the fuel cell otherwise by the air, i.e., oxygen, remaining in the anode 15.

Also, in the present exemplary embodiment, since the valve unit 90 is configured as a 4-way valve, the air exhaust side and the air supply side of the stack 10 can be opened or closed via a single valve. Accordingly, the structure of the overall system can be simplified and light-weighted, the fabrication unit cost can be reduced, the vehicle package can be improved, the system can be modularized, maintenance characteristics of the system can be enhanced, and the failure rate can be reduced.

Furthermore, the control mechanisms of the present invention may be embodied as computer readable media on a computer readable medium containing executable program instructions executed by a processor. Examples of the computer readable mediums include, but are not limited to, ROM, RAM, compact disc (CD)-ROMs, magnetic tapes, floppy disks, and optical data storage devices. The computer readable recording medium can also be distributed in network coupled computer systems so that the computer readable media is stored and executed in a distributed fashion.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

10 . . . stack
17 . . . fuel cell
30 . . . air supply unit
31 . . . air blower
50 . . . humidifying device
51 . . . housing
55 . . . membrane module
56 . . . hollow fiber membrane
70 . . . hydrogen supply unit
80 . . . hydrogen recirculation unit
90 . . . valve unit
91 . . . air supply path
93 . . . air exhaust path
53 . . . valve body component
95 . . . opening and closing component
99 . . . actuator

What is claimed is:

1. A fuel cell system comprising:
a stack configured as an aggregate of unit fuel cells;
an air supply unit to supply external air to a cathode of the fuel cell;
a humidifier to exchange exhaust air of high temperature and humidity exhausted from the cathode and supply air supplied from the air supply unit to humidify the supply air, and to supply the humidified air to the cathode;
a hydrogen supply unit to supply hydrogen to an anode of the fuel cell; and
a valve unit configured to be connected to the stack and the humidifier and to prevent external air from being introduced to an air supply path and an air exhaust path through the humidifier when the stack is turned off,
wherein the valve unit comprises a valve body component constituting the air supply path as first and second valve passages and the air exhaust path as third and fourth valve passages and an opening and closing component for opening and closing the air supply path and the air exhaust path.

2. The system of claim 1, wherein the valve unit is configured as a 4-way valve.

3. The system of claim 1, wherein the humidifier comprises:
a housing; and
a hollow fiber membrane disposed in the interior of the housing and allowing the exhaust air and the supply air to be moisture-exchanged therethrough to humidify the supply air.

4. The system of claim 3, wherein the housing comprises a second inlet to allow the supply air to be introduced therethrough, a first outlet to allow the humidified air to be exhausted therethrough, and a second outlet to allow the exhausted air, from which moisture has been removed, to be exhausted to the air.

5. The fuel cell system of claim 4, wherein the air supply path is connected to the first outlet, and the air exhaust path is connected to the first inlet.

6. The system of any one of claim 5, wherein when the stack is started, the opening and closing component opens the first and second valve passages as the air supply path connecting the stack and the humidifier, and opens the third and fourth valve passages as the air exhaust path connecting the stack and the humidifier.

7. The system of claim 6, wherein when the stack is turned off, the opening and closing component closes the first and second valve passages as the air supply path connecting the stack and the humidifier, and closes the third and fourth valve passages as the air exhaust path connecting the stack and the humidifier.

8. The system of claim 4, wherein the first and fourth valve passages are connected to the humidifier, and the second and third valve passages are connected to the stack.

9. The system of claim 4, wherein the first valve passage is connected to the first outlet, the second valve passage is connected to an air supply side, the third valve passage is connected to an air exhaust side of the stack, and the fourth valve passage is connected to the first inlet.

10. The system of claim 1, wherein the opening and closing component comprises an operational plunger rotatably mounted in the interior of the valve body component to open and close the air supply path and the air exhaust path.

11. The system of claim 10, wherein the valve unit comprises an actuator for rotating the operational plunger.

12. A non-transitory computer readable medium containing executable program instructions executed by a processor to control an actuator in a valve unit of a fuel cell vehicle, comprising:
program instructions that activate the actuator to provide a first rotary force to a opening and closing component upon receiving a control signal indicating the fuel cell is turned on, wherein a first and second valve passage are opened as a air supply paths connecting a stack and a humidifier and a third and fourth valve passage are opened as an air exhaust path connecting the stack and the humidifier; and
program instructions that activate the actuator to provide a second rotary force, opposite to the first rotary force, to the opening and closing component upon receiving a control signal indicating that the fuel cell is turned off, wherein the first and second valve passages are closed, and the third and fourth valve passages are closed.
